(19) United States
(12) Patent Application Publication
(10) Pub. No.: US 2014/0143277 A1
(43) Pub. Date: May 22, 2014

(54) METHOD AND DEVICE FOR MATCHING FRIEND RELATIONSHIP CHAIN IN INSTANT MESSAGING TOOL

(71) Applicant: Tencent Technology (Shenzhen) Company Limited, Shenzhen (CN)

(72) Inventors: Yu Yang, Shenzhen (CN); Yiping Chen, Shenzhen (CN); Tingting An, Shenzhen (CN); Rongjun Feng, Shenzhen (CN); Zhiyong Lai, Shenzhen (CN)

(73) Assignee: Tencent Technology (Shenzhen) Company Limited, Shenzhen (CN)

(21) Appl. No.: 14/163,958

(22) Filed: Jan. 24, 2014

Related U.S. Application Data
(63) Continuation of application No. PCT/CN2012/078443, filed on Jul. 10, 2012.

(30) Foreign Application Priority Data
Aug. 3, 2011 (CN) 201110220780.7

(51) Int. Cl. G06F 17/30; H04L 12/58

(52) U.S. Cl. CPC G06F 17/30539; H04L 51/04
USPC 707/776

(57) ABSTRACT

Disclosed is a method and device for matching a friend relationship chain in an instant messaging tool. The method includes: performing data analysis on data information of a user; performing data mining on data information of other mass users according to an analysis result; and performing data matching between a mining result and the analysis result of the user. The device includes: a data analyzing module, a data mining module, and a data matching module. According to the technical solutions provided in the present disclosure, other users desired by the user are automatically matched for the user. The whole matching process requires no manual operation, which reduces usage threshold for a friend relationship chain matching system. In addition, as regards matching based on the user information, the matched users have a strong correlation with the user, and the matching quality is high.

This application is a continuation of PCT/CN2012/078443, filed Jul. 10, 2012, which claims priority to Chinese Patent Application No. 201110220780.7, filed before Chinese Patent Office on Aug. 3, 2011 and entitled “METHOD AND DEVICE FOR MATCHING FRIEND RELATIONSHIP CHAIN IN INSTANT MESSAGING TOOL”, each of which is hereby incorporated by reference herein in its entirety.

### TECHNICAL FIELD

The present disclosure relates to the instant messaging field, and in particularly, to a method and device for matching a friend relationship chain in an instant messaging tool.

### BACKGROUND

One critical function of instant messaging software is to assist users to establish friend relationship chains. The number of friend relationship chains and the quality thereof will affect the retention and activeness of the user on an instant messaging platform to a great extent. It is a critical issue for users using the instant messaging software to establish a considerable number of high quality friend relationship chains.

Currently, the friend relationship chain is mainly implemented by using the following method:

When a user inputs a search condition, the system searches for user(s) satisfying the search condition from all the users or online users, and recommends the searched out user(s) to the user. Depending on the search condition, the search is categorized into accurate search and conditional search. The accurate search requires the user to input an accurate account of the user to be searched, and the system searches for the corresponding user according to the accurate account input. The conditional search requires the user to select or input some search conditions, for example, information such as country and province, and the system searches for the corresponding user according to the search conditions.

During the implementation of the present disclosure, the inventors find that the prior art has at least the following problems:

Currently, during matching of the friend relationship chain, manual operations by users are needed. This requires that the users have a basic knowledge about a friend relationship chain matching system. In addition, the search result is closely related to the familiarity of the users with the system. Users who are familiar with the system probably search out satisfied or desired results; whereas users who are not familiar with the system probably search out unsatisfied or undesired results. In this way, user experience is affected.

### SUMMARY

Embodiments of the present disclosure provide a method and device for matching a friend relationship chain in an instant messaging tool, to automatic match users desired by a user for the user. The technical solutions are as follows:

A method for matching a friend relationship chain in an instant messaging tool includes:

performing data analysis on data information of a user;

performing data mining on data information of other mass users according to an analysis result; and

performing data matching between a mining result and the analysis result of the user.

A device for matching a friend relationship chain in an instant messaging tool includes:

a data analyzing module, configured to perform data analysis on data information of a user;

a data mining module, configured to perform data mining on data information of other mass users according to an analysis result; and

a data matching module, configured to perform data matching between a mining result and the analysis result of the user.

The technical solutions provided in the embodiments of the present disclosure achieve the following beneficial effects:

Data analysis is performed on data information of a user, data mining is performed on data information of other mass users according to an analysis result, and data matching is performed between a mining result and the analysis result of the user. In this way, other users desired by the user are automatically matched for the user. The whole matching process requires no manual operation, which reduces usage threshold for a friend relationship chain matching system. In addition, as regards matching based on the user information, the matched users have a strong correlation with the user, and the matching quality is high. This improves the success rate of establishing the friend relationship chain.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art can derive other accompanying drawings from these accompanying drawings without any creative efforts.

FIG. 1 is a flowchart of a method for matching a friend relationship chain in an instant messaging tool according to an embodiment of the present disclosure;

FIG. 2 is another flowchart of a method for matching a friend relationship chain in an instant messaging tool according to an embodiment of the present disclosure;

FIG. 3 is a schematic structural diagram of a device for matching a friend relationship chain in an instant messaging tool according to an embodiment of the present disclosure; and

FIG. 4 is another schematic structural diagram of a device for matching a friend relationship chain in an instant messaging tool according to an embodiment of the present disclosure.

### DETAILED DESCRIPTION

To make the objectives, technical solutions, and advantages of the present disclosure clearer, the embodiments of the present disclosure are described in detail below with reference to the accompanying drawings.

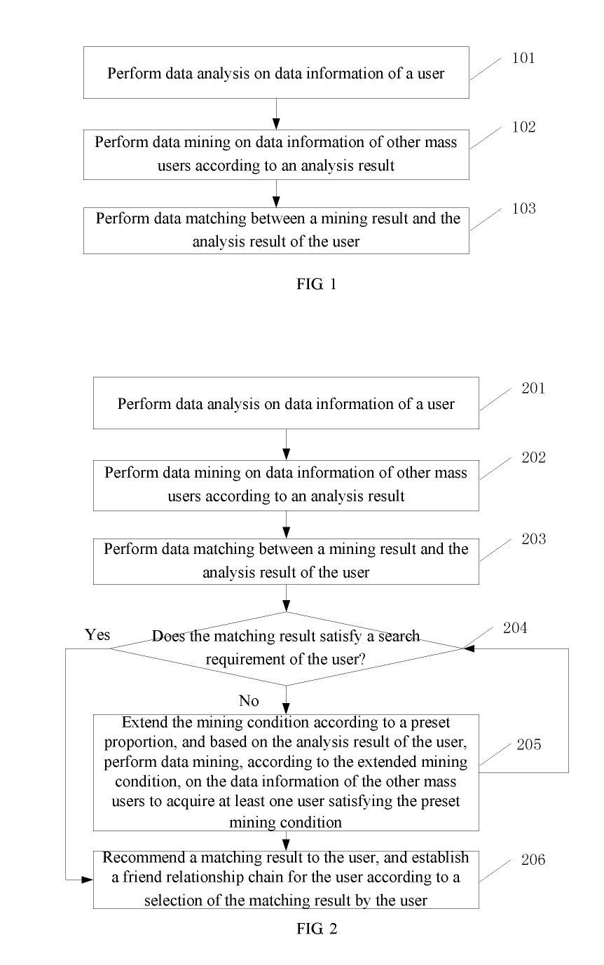

Referring to FIG. 1, an embodiment of the present disclosure provides a method for matching a friend relationship chain in an instant messaging tool. The method includes the following steps:

101: performing data analysis on data information of a user;

102: performing data mining on data information of other mass users according to an analysis result; and

103: performing data matching between a mining result and the analysis result of the user.

Referring to FIG. 2, the method for matching a friend relationship chain in an instant messaging tool is described in detail as follows with reference to specific examples.

201: Performing data analysis on data information of a user.

Specifically, data analysis may be performed on one or multiple pieces of data information among the data information of the user.

For example, the data information of the user includes age, gender, geographic location, nationality, hobby, and the like; data analysis may be performed on one item of data information such as age, or performed on multiple pieces of data information such as age, gender, and geographic location.

The more pieces of data information for data analysis, the stronger the correlation between matched users and the user, the higher the matching quality, and the higher the success rate of establishing the field relationship chain.

202: Performing data mining on data information of other mass users according to an analysis result.

Specifically, based on the analysis result of the user, data mining is performed on the data information of the other mass users to acquire at least one user satisfying the preset mining condition.

The mining condition is acquired by setting a search scope in each dimension of the analysis result. For example, if the analysis result of the user is related to the geographic location, age, and gender, the mining condition may be set as a search scope of 100 km, at the age of 2, and male users. If the analysis result of the user specifically indicates Beijing city, 28 years old, and female, and the city information may be converted into corresponding latitude and longitude information, then the mining condition may be set as a search scope of 100 km centering around Beijing, at the age of 26 to 30, and male users. In this way, the mining result from the data information of other mass users will be male users at the age of 26 to 30 within 100 km centering around Beijing. It should be noted that if the analysis result is multi-dimensional, the search scope corresponding to the mining condition is a multi-dimensional spatial area.

Furthermore, the other mass users may be all the users or online users in a relationship chain matching system. In the relationship chain matching system, a queue of all the users or a queue of the online users may be maintained, and a desired user may be directly searched in the corresponding queue depending on target search groups. The users in the relationship chain matching system join the system when they are intended to establish a friend relationship chain. When a user stays in a preset state, for example, when the user is a new user or the number of online friends of the user is smaller than a preset value, a link of joining the relationship chain matching system is displayed on the client of the user. If the user clicks the link and applies for joining the relationship chain matching system, it indicates that the user is intended to establish a friend relationship chain.

203: Performing data matching between a mining result and the analysis result of the user.

Specifically, priorities are set for all the dimensions of the analysis result, according to the priorities, similarity matching is performed between the mining result and the analysis result of the user.

When the analysis result has a plurality of dimensions, the priorities in this embodiment are multi-dimensional priorities, which are priorities related to multi-dimensional factors.

For example, with respect to three-dimensional priorities related to age, location, and gender, one possible sequence of the three-dimensional priorities is as follows: using a search result with a close age section, the same location, but a different gender as the top priority; using a search result with a different gender and a different age section, but the same location as the second priority; using a search result with a different gender, location, and age section as the third priority; using a search result with the same location, age section, and gender as the fourth priority; using a search result with the same location and the same gender, but a different age as the fifth priority; and using a search result with the same age section and the same gender, but different location as the sixth priority; and using a search result with the same gender, but a different age section and a different location as the seventh priority. Assuredly, according to system settings, the three-dimensional priorities may also be in another sequence, which is not listed herein exhaustively.

Assume that the mining result includes information as follows: the age of user A is 28, the location of user A is Beijing, and the gender of user A is male; the age of user B is 28, the location of user B is Beijing, and the gender of user B is male; the age of user C is 29, the location of user C is Beijing, and the gender of user C is male; . . . and the analysis result of the user specifically indicates Beijing city, 28 years old, female.

Correspondingly, according to the three-dimensional priorities, similarity matching is performed between the mining result and the analysis result of the user. To be specific, the age section of user A and the age section of user B are respectively the same as the age section of the user, the location of user A and the location of user B are respectively the same as the location of the user, and the gender of user A and the gender of user B are respectively different from the gender of the user; therefore, the acquired matching result includes user A and user B, where user A and user B enjoy the top priority. The age section of user C is different from the age section of the user, the location of user C is the same as the location of the user, and the gender of user C is different from the gender of the user; therefore, the acquired matching result includes user C, where user C enjoys the second priority.

Furthermore, the method may further include step 206. Optionally, before step 205, the method may further include steps 204 and 205.

204: Judging whether the matching result satisfies a search requirement of the user, if the search requirement is not satisfied, performing step 205, and if the search requirement is satisfied, performing step 206.

For example, if the search requirement of the user indicates 28 years old, Beijing, and male, user A and user B that satisfy the search requirement are searched out from users A, B and C included in the matching result.

205: If the search requirement is not satisfied, extending the mining condition according to a preset proportion, and based on the analysis result of the user, performing data mining, according to the extended mining condition, on the data information of the other mass users to acquire at least one user satisfying the preset mining condition.

The mining condition is extended according to a preset proportion, which may be acquired by extension of the search scope in one or multiple dimensions.

Steps 204 and 205 are cyclically performed until the search requirement is satisfied, and then step 206 is performed.

206: Recommending a matching result to the user, and establishing a friend relationship chain for the user according to a selection of the matching result by the user.

According to this embodiment, data analysis is performed on data information of a user, data mining is performed on data information of other mass users according to an analysis result, and data matching is performed between a mining result and the analysis result of the user. In this way, other users desired by the user are automatically matched for the user. The whole matching process requires no manual operation, which reduces usage threshold for a friend relationship chain matching system. In addition, matching is based on the user information, the matched users have a strong correlation with the user, and the matching quality is high. This improves the success rate of establishing the friend relationship chain.

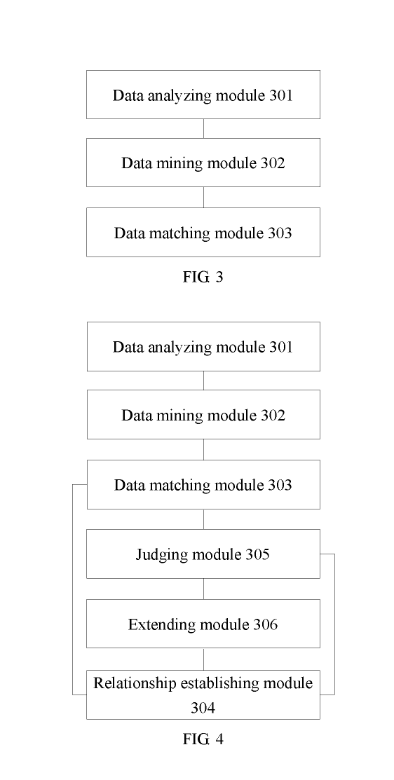

Referring to FIG. 3, an embodiment of the present disclosure provides a device for matching a friend relationship chain in an instant messaging tool. The device includes:

a data analyzing module 301, configured to perform data analysis on data information of a user;

a data mining module 302, configured to perform data mining on data information of other mass users according to an analysis result; and

a data matching module 303, configured to perform data matching between a mining result and the analysis result of the user.

The data analyzing module 301 is specifically configured to:

perform data analysis on one or multiple pieces of data information among the data information of the user; where the more pieces of data information for data analysis, the stronger the correlation between matched users and the user, the higher the matching quality, and the higher the success rate of establishing the field relationship chain.

The data mining module 302 is specifically configured to:

based on the analysis result of the user, perform data mining, according to a preset mining condition, on the data information of the other mass users to acquire at least one user satisfying the preset mining condition; where the mining condition is acquired by setting a search scope in each dimension of the analysis result. Furthermore, the other mass users may be all the users or online users in a relationship chain matching system. In the relationship chain matching system, a queue of all the users or a queue of the online users may be maintained, and a desired user may be directly searched in the corresponding queue depending on target search groups. The users in the relationship chain matching system join the system when they are intended to establish a friend relationship chain. When a user stays in a preset state, for example, when the user is a new user or the number of online friends of the user is smaller than a preset value, a link of joining the relationship chain matching system is displayed on the client of the user. If the user clicks the link and applies for joining the relationship chain matching system, it indicates that the user is intended to establish a friend relationship chain.

The data mining module 302 is specifically configured to:

Specifically, assume that the analysis result contains priorities in all dimensions, according to the priorities, similarity matching is performed between the mining result and the analysis result of the user.

When the analysis result has a plurality of dimensions, the priorities in this embodiment are multi-dimensional priorities, which are priorities related to multi-dimensional factors. For example, with respect to three-dimensional priorities related to age, location, and gender, one possible sequence of the three-dimensional priorities is as follows: using a search result with a close age section, the same location, but a different gender as the highest priority; using a search result with a different gender and a different age section, but the same location as the second priority; using a search result with a different gender, location, and age section as the third priority; using a search result with the same location, age section, and gender as the fourth priority; using a search result with the same location and the same gender, but a different gender as the fifth priority; and using a search result with the same age section and the same gender, but different location as the sixth priority; and using a search result with the same gender, but a different age section and a different location as the seventh priority. Assuredly, according to system settings, the three-dimensional priorities may also be in another sequence, which are not listed herein exhaustively.

Furthermore, referring to FIG. 4, the device further includes:

a relationship establishing module 304, configured to: after data matching is performed between a mining result and the analysis result of the user, recommend a matching result to the user, and establish a friend relationship chain for the user according to a selection of the matching result by the user

Furthermore, the device further includes:

a judging module 305, configured to: judge whether the matching result satisfies a search requirement of the user; if the search requirement is satisfied, perform an operation of the extending module 306; and if the search requirement is satisfied, perform an operation of the relationship establishing module 304;

an extending module 306, configured to extend the mining condition according to a preset proportion, and based on the analysis result of the user, perform data mining, according to the extended mining condition, on the data information of the other mass users to acquire at least one user satisfying the preset mining condition; where the mining condition is extended according to a preset proportion, which may be acquired by extension of the search scope in one or multiple dimensions.

It should be noted that the functional modules involved in this embodiment may be configured on a server or on a plurality of servers, which is not limited in this embodiment.

According to this embodiment, data analysis is performed on data information of a user, data mining is performed on data information of other mass users according to an analysis result, and data matching is performed between a mining result and the analysis result of the user. In this way, other users desired by the user are automatically matched for the user. The whole matching process requires no manual operation, which reduces usage threshold for a friend relationship chain matching system. In addition, as regards matching based on the user information, the matched users have a strong correlation with the user, and the matching quality is high. This improves the success rate of establishing the friend relationship chain.

Persons of ordinary skill in the art should understand that all or part of steps of the preceding methods may be implemented by hardware or hardware following instructions of programs. The programs may be stored in a computer readable storage medium. The storage medium may be a read only memory, a magnetic disk, or a compact disc-read only memory.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

What is claimed is:

1. A method for matching a friend relationship chain in an instant messaging tool, comprising:
performing data analysis on data information of a user;
performing data mining on data information of other mass users according to an analysis result; and
performing data matching between a mining result and the analysis result of the user.

2. The method according to claim 1, wherein the performing data analysis on data information of a user specifically comprises:
performing data analysis on one or multiple pieces of data information among the data information of the user.

3. The method according to claim 1, wherein the performing data mining on data information of other mass users according to an analysis result specifically comprises:
based on the analysis result of the user, performing data mining, according to a preset mining condition, on the data information of the other mass users to acquire at least one user satisfying the preset mining condition.

4. The method according to claim 3, wherein the data mining condition is acquired by setting a search scope in each dimension of the analysis result.

5. The method according to claim 1, wherein the performing data matching between a mining result and the analysis result of the user specifically comprises:
setting a priority for each of all dimensions of the analysis result; and
performing similarity matching between the mining result and the analysis result of the user according to the priorities.

6. The method according to claim 1, wherein after the performing data matching between a mining result and the analysis result of the user, the method further comprises:
recommending a matching result to the user, and establishing a friend relationship chain for the user according to a selection of the matching result by the user.

7. The method according to claim 6, wherein before the recommending a matching result to the user, the method further comprises:
judging whether the matching result satisfies a search requirement of the user; and if the search requirement is satisfied, performing an operation of recommending the matching result to the user.

8. The method according to claim 7, further comprising:
if the matching result does not satisfy the search requirement of the user, extending the mining condition according to a preset proportion, and based on the analysis result of the user, performing data mining, according to the extended mining condition, on the data information of the other mass users to acquire at least one user satisfying the preset mining condition.

9. The method according to claim 1, wherein the other mass users are all the users or online users in a relationship chain matching system, wherein the users in the relationship chain matching system join the system when they are intended to establish a friend relationship chain.

10. A device for matching a friend relationship chain in an instant messaging tool, comprising:
a data analyzing module, configured to perform data analysis on data information of a user;
a data mining module, configured to perform data mining on data information of other mass users according to an analysis result; and
a data matching module, configured to perform data matching between a mining result and the analysis result of the user.

11. The device according to claim 10, wherein the data analyzing module is specifically configured to:
perform data analysis on one or multiple pieces of data information among the data information of the user.

12. The device according to claim 10, wherein the data mining module is specifically configured to:
based on the analysis result of the user, perform data mining, according to a preset mining condition, on the data information of the other mass users to acquire at least one user satisfying the preset mining condition.

13. The device according to claim 12, wherein the data mining condition is acquired by setting a search scope in each dimension of the analysis result.

14. The device according to claim 10, wherein the data mining module is specifically configured to:
set a priority for each of all dimensions of the analysis result; and
perform similarity matching between the mining result and the analysis result of the user according to the priorities.

15. The device according to claim 10, further comprising:
a relationship establishing module, configured to: after data matching is performed between a mining result and the analysis result of the user, recommend a matching result to the user, and establish a friend relationship chain for the user according to a selection of the matching result by the user

16. The device according to claim 15, further comprising:
a judging module, configured to judge whether the matching result satisfies a search requirement of the user; and if the search requirement is satisfied, perform an operation of recommending the matching result to the user.

17. The device according to claim 16, further comprising:
an extending module, configured to: if the matching result does not satisfy the search requirement of the user, extend the mining condition according to a preset proportion, and based on the analysis result of the user, perform data mining, according to the extended mining condition, on the data information of the other mass users to acquire at least one user satisfying the preset mining condition.

18. The device according to claim 10, wherein the other mass users are all the users or online users in a relationship chain matching system, wherein the users in the relationship chain matching system join the system when they are intended to establish a friend relationship chain.
